(19) United States
(12) Patent Application Publication
(10) Pub. No.: US 2022/0323882 A1
(43) Pub. Date: Oct. 13, 2022

(54) HONEY PROCESSING APPARATUS

(71) Applicant: Dustin James Cobbett, Fort Nelson (CA)

(72) Inventor: Dustin James Cobbett, Fort Nelson (CA)

(21) Appl. No.: 17/224,261

(22) Filed: Apr. 7, 2021

(51) Int. Cl. B01D 17/02; B01D 17/04; B01D 17/12; A23L 21/25; A23L 5/20; A23L 3/00; A23L 3/16; F28D 1/02; F28F 1/00; F28D 1/047

(52) U.S. Cl. CPC B01D 17/0214; B01D 17/042; B01D 17/12; A23L 21/25; A23L 5/21; A23L 3/003; A23L 3/001; A23L 3/16; F28D 1/0213; F28F 1/00; F28D 1/0472; A23V 2002/00; F28F 2250/08

(57) ABSTRACT

A honey processing apparatus that is configured to provide processing of a wax/honey emulsion so as to separate the honey from the wax and provide separate collection thereof. The present invention includes a vessel having a first chamber and a second chamber. The first chamber includes an interior volume having a heating fluid disposed therein. The second chamber is also disposed within the interior volume of the first chamber and wherein the heating fluid is surroundably present thereto. A coil is present within the second chamber and the coil is fluidly coupled with the heating fluid. A pump is operably coupled to the coil and is configured to provide closed-loop recirculation of the heating fluid within the coil so as to provide heating of the wax/honey emulsion in order to facilitate the separation thereof. A honey extraction tube coupled with the second chamber provides extraction of the honey.

### FIELD OF THE INVENTION

The present invention relates generally to filtration and pasteurization processes and apparatus, more specifically but not by way of limitation, a honey filtration and pasteurization apparatus that is provided in a single vessel assembly wherein the single vessel assembly is configured to facilitate an improved method of filtration of honey and separation from wax.

### BACKGROUND

Millions of people regularly incorporate honey as part of their diet. Honey in its raw form is a very healthy food that is a source for antioxidants as well as antibacterial and antifungal compounds. Many people choose to ingest a small amount of honey daily due to the health benefits of honey. The interest in producing one's own honey has been expanding significantly and as such beekeeping popularity continues to rise. Producing honey is not void of challenges and one such challenge is to separate the honey from the materials also present in honey production such as but not limited to wax and pollen.

In order to separate the honey from the wax the compound must be placed at a certain temperature. Some methods to achieve the aforementioned include the use of hot houses and other techniques but these require a great deal of labor. As the frames of the bee hives will accumulate wax, these frames will have to be sheered which again leads to a time consuming process. Furthermore, sheering of the wax typically results in the wax being discarded which can be saved for use in crafts and other needs. Hobbyists that process their own honey are typically left with conventional methods that require more time than some individuals may have to direct towards the harvesting of honey.

Accordingly, there is a need for an apparatus that is operable to provide efficiencies in harvesting honey wherein the present invention is configured to receive a wax/honey combination and provide separation thereof wherein a user can then harvest the honey as well as retain the wax for subsequent use.

### SUMMARY OF THE INVENTION

It is the object of the present invention to provide a honey processing apparatus that is configured to provide processing of raw honey wherein the present invention in a preferred embodiment is embodied as a single vessel.

Another object of the present invention is to provide a honey pasteurization and filtration device that is operable to separate honey from wax using temperature manipulation wherein the vessel of the present invention includes a first chamber and a second chamber.

A further object of the present invention is to provide a honey processing apparatus that is configured to provide processing of raw honey wherein the second chamber is disposed within the interior volume of the first chamber.

Still another object of the present invention is to provide a honey pasteurization and filtration device that is operable to separate honey from wax using temperature manipulation wherein the first vessel has disposed therein a heating fluid such as but not limited to water.

An additional object of the present invention is to provide a honey processing apparatus that is configured to provide processing of raw honey wherein the vessel is configured to be superposed a controllable heat source.

Yet a further object of the present invention is to provide a honey pasteurization and filtration device that is operable to separate honey from wax using temperature manipulation wherein the present invention further includes a coil.

Another object of the present invention is to provide a honey processing apparatus that is configured to provide processing of raw honey wherein the coil is disposed within the interior volume of the second chamber and is fluidly coupled to the heating fluid disposed within the interior volume of the first chamber.

Still an additional object of the present invention is to provide a honey pasteurization and filtration device that is operable to separate honey from wax using temperature manipulation wherein the first chamber further includes a heating fluid tube and drain valve.

A further object of the present invention is to provide a honey processing apparatus that is configured to provide processing of raw honey wherein the second chamber includes a honey extraction tube from which heated honey will egress therefrom.

Still another object of the present invention is to provide a honey pasteurization and filtration device that is operable to separate honey from wax using temperature manipulation wherein the second chamber has operably formed therewith an emulsion introduction element that provides introduction of a honey/wax emulsion underneath the wax cap formed in the second chamber during the processing process.

Yet an additional object of the present invention is to provide a honey processing apparatus that is configured to provide processing of raw honey wherein the second chamber further includes a wax tube and drain valve assembly.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a honey processing apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

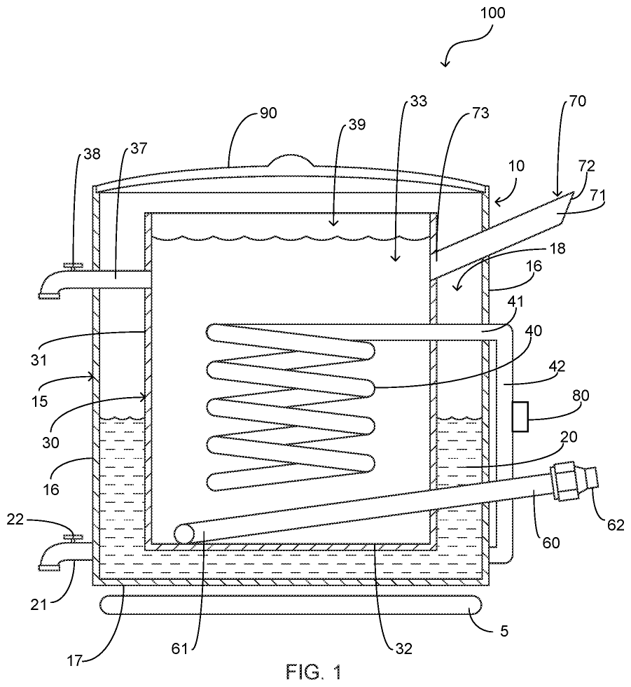

Referring in particular to FIG. 1 herein, the honey processing apparatus 100 includes a vessel 10. The vessel 10 is manufactured from a suitable durable material such as but not limited to stainless steel. It should be understood within the scope of the present invention that the diagrammatic view provided herewith is exemplary only and that the vessel 10 of the present invention is contemplated to be constructed in various sizes and shapes. The vessel 10 is operated by superposing on a heating element 5. The heating element 5 is a conventional controllable heating element such as but not limited to a stovetop heating element. It is contemplated within the scope of the present invention that the honey processing apparatus 100 could be superposed a heating element 5 as shown and described herein or that a heating element could be integrated into the bottom of the vessel 10. It is desirable within the scope of the present invention that the heating element 5 be able to heat the interior volume of the honey processing apparatus 100 to at least sixty three degrees in order to facilitate the processing of honey that is disposed therein. It should be understood within the scope of the present invention a heating element could be integrated into the first chamber 15 as an alternate technique of providing heat.

The vessel 10 includes a first chamber 15. The first chamber 15 includes a bottom 17 and a wall 16 contiguously formed to create interior volume 18. A preferred embodiment of the present invention utilizes a first chamber 15 that is annular in shape but it is contemplated within the scope of the present invention that the first chamber 15 could be alternate shapes and as such have various quantities of walls. It should be further understood within the scope of the present invention that the first chamber 15 could be manufactured in alternate sizes. The interior volume 18 has disposed therein a heating fluid 20. As will be discussed further herein, the heating fluid 20 is heated to a desired temperature and distributed through the coil 40 in a closed loop manner. Operably coupled to the first chamber 15 is drain tube 21. Drain tube 21 is fluidly coupled to the interior volume 18 of the first chamber 15. The drain tube 21 includes a valve 22 wherein the valve 22 is a conventional valve operable to control flow through the drain tube 21. The drain tube and valve 22 are provided in order to evacuate the interior volume 18 of the first chamber 15 of the heating fluid 20. While no particular heating fluid 20 is required, good results have been achieved utilizing a heating fluid 20 that is distilled water.

Disposed within the first chamber 15 is the second chamber 30. Second chamber 30 is manufactured from a suitable durable material such as but not limited to stainless steel. The second chamber 30 is secured within the interior volume 18 utilizing conventional structural supports. The second chamber 30 includes wall 31 and bottom 32 contiguously formed to create interior volume 33. The second chamber 30 is mateably shaped to the first chamber 15. Similarly to the first chamber 15, it is contemplated within the scope of the present invention that the second chamber 30 could be comprised of alternate quantities of walls 31. It should be further understood within the scope of the present invention that the second chamber 30 could be provided in alternate sizes wherein the size requirement is such that the second chamber 30 fits within the interior volume 18 of the first chamber 15 and have the heating fluid 18 surroundably present thereto.

The second chamber 30 includes wax drain tube 37 having valve 38. The wax drain tube 37 is positioned proximate the upper end of the second chamber 30 as during operation of the honey processing apparatus 100 the wax/honey emulsion is separated once at temperature. At temperature the wax will be the top layer and the honey will be the bottom layer. When desired during operation of the honey processing apparatus 100, a user will utilize the wax drain tube 37 to remove and capture the wax for use thereof as desired. A honey extraction tube 60 is operably coupled to the second chamber 30 proximate the bottom 32 thereof. The honey extraction tube 60 is fluidly coupled to the interior volume 33 of the second chamber 30 and is a hollow tube. The honey extraction tube 60 is positioned in an angular manner wherein end 62 is above end 61 so as to control the flow of honey therethrough. It should be understood within the scope of the present invention that the honey extraction tube 60 is movably mounted so as to position end 62 in alternate locations. As the honey processing apparatus 100 begins to operate at temperature and the wax/honey emulsion separates into a wax layer and a honey layer wherein the honey is at the bottom of the interior volume 33. As the honey is heated to approximately sixty-three degrees, the viscosity of the honey is reduced enabling flow through the honey extraction tube 60. It is contemplated within the scope of the present invention that the honey processing apparatus 100 could have insulating material wrapped therearound for thermal efficiency. Furthermore, insulating material could be disposed around the outer surface of the honey extraction tube 60. While not illustrated herein, it is contemplated within the scope of the present invention that the honey extraction tube could have a valve operably coupled thereto.

An emulsion introduction element 70 is operably coupled to the second chamber 30. The emulsion introduction element 70 includes a hollow passage 71 intermediate ends 72,73. The emulsion introduction element 70 is secured to the second chamber 30 utilizing suitable techniques and is further journaled through the wall 16 of the first chamber 15. The emulsion introduction element 70 provides a technique to introduce more supply of a wax/honey emulsion harvested for processing by the honey processing apparatus 100. The emulsion introduction element 70 provides the ability to introduce more supply of a wax/honey emulsion during operation of the honey processing apparatus 100. It should be understood within the scope of the present invention that a wax/honey emulsion can be initially deposited into the interior volume 33 via opening 39 and subsequent deposits thereof can be via the emulsion introduction element 70.

Operably disposed within the interior volume 33 of the second chamber 30 is the coil 40. Coil 40 is manufactured from stainless steel tubing and is hollow so as to provide passage of the heating fluid 18 therethrough. The coil 40 includes portions 41, 42 contiguously formed therewith so as to fluidly couple with the heating fluid 18 and provide passage of the heating fluid 18 through the coil 40. A pump 80 is operably coupled to the coil 40 wherein the pump 80 is a recirculating pump providing closed loop recirculation of the heating fluid 18 through the coil 40. As the heating fluid 18 is heated and passed through the coil 40 continuously, the wax/honey emulsion deposited within the interior volume 33 begins to separate at around sixty-three degrees centigrade. The coil 40 being disposed within the interior volume 33 allows a maintenance of a temperature of the interior volume 33 promoting effective separation of the wax/honey emulsion. While one coil 40 is illustrated and discussed herein, it is contemplated within the scope of the present invention that more than one coil could be deployed. Additionally, it should be understood within the scope of the present invention that the coil 40 could be provided in alternate sizes. Furthermore, it should be understood within the scope of the present invention that an alternate heating element could be employed in place of and/or in conjunction with the coil 40. By way of example but not limitation, a heat exchanger or other type of heating element.

The vessel 10 includes a lid 90 operably coupled to the top of the second chamber 30. The lid 90 in a preferred embodiment is glass so as to provide visibility into the honey processing apparatus 100 during operation thereof. The lid 90 further provides the ability to assist in the maintenance of a desired operating temperature during operation of the honey processing apparatus 100. It should be understood within the scope of the present invention that the honey processing apparatus 100 could be provide and/or operated with or without lid 90. It is contemplated within the scope of the present invention that the lid 90 could cover the first chamber 15, second chamber 30 or both.

While a preferred embodiment has been discussed and illustrated herein, it is contemplated within the scope of the present invention that the honey processing apparatus 100 could be comprised of a single chamber having an interior volume configured to receive the coil 40 therein. In this embodiment, the coil 40 could be operably coupled to a separate container of heating fluid 20 wherein the pump 80 would recirculate the fluid 20 from its source and the source of the fluid would have a temperature controller to provide the desired temperature of the wax/honey emulsion disposed within the single chamber.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A honey processing apparatus configured to provide separation of wax and honey wherein the honey processing apparatus comprises:
a vessel, said vessel having at least one chamber, said at least one chamber having at least one wall and a bottom integrally formed to create an interior volume, said at least one chamber having an opening opposite said bottom, said at least one chamber operable to have an emulsion disposed therein;
a heating source, said heating source being disposed within said interior volume of said at least one chamber, said heating source being comprised of a hollow tube, said heating source being configured in a continuous closed loop, said heating source having a fluid disposed therein, said fluid configured to be subjected to a heating source so as to increase a temperature of the fluid greater than that of an ambient temperature of an area wherein the honey processing apparatus is disposed.

2. The honey processing apparatus as recited in claim 1, and further including a honey extraction tube, said honey extraction tube being operably coupled to said at least one chamber, said honey extraction tube being hollow, said honey extraction tube having a first end and a second end.

3. The honey processing apparatus as recited in claim 2, and further including an emulsion introduction element, said emulsion introduction element being operably coupled to said at least one chamber, said emulsion introduction element being hollow and having a first end and a second end, said second end being proximate the interior volume of said at least one chamber.

4. The honey processing apparatus as recited in claim 3, wherein said second end of said honey extraction tube is distally located from said at least one chamber and wherein said second end is above said first end of said honey extraction tube.

5. The honey processing apparatus as recited in claim 4, and further including at least one drain tube, said at least one drain tube operably coupled with the interior volume of said at least one chamber, said at least one drain tube configured to provide removal of materials disposed within said interior volume of said at least one chamber.

6. The honey processing apparatus as recited in claim 5, wherein said vessel is operably coupled to a heating element, said heating element configured to increase a temperature of the fluid to approximately sixty three degrees centigrade.

7. A honey processing apparatus that is operable to provide separation of wax and honey and further provide separate collection thereof wherein the honey processing apparatus comprises:
a vessel, said vessel having a first chamber and a second chamber, said first chamber having a bottom and at least one wall forming an interior volume, said first chamber having an opening distal to said bottom, said second chamber having at least one wall and a bottom integrally formed to create an interior volume, said second chamber being mateably shaped with said first chamber, said second chamber being disposed within said interior volume of said first chamber;
a heating fluid, said heating fluid being disposed within said interior volume of said first chamber, said heating fluid configured to be surroundably present to the second chamber;
a coil, said coil being disposed within said interior volume of said second chamber, said coil being comprised of a hollow tube, said coil being fluidly coupled with the heating fluid, said coil configured to provide recirculation of said heating fluid therethrough; and
a honey extraction tube, said honey extraction tube being operably coupled to said second chamber proximate the bottom thereof, said honey extraction tube being hollow, said honey extraction tube having a first end and a second end, said first end being proximate said bottom of said second chamber.

8. The honey processing apparatus that is operable to provide separation of wax and honey as recited in claim 7, wherein said second end of said honey extraction tube is at a level higher than said first end, said honey extraction tube being oriented in an upwardly angular manner.

9. The honey processing apparatus that is operable to provide separation of wax and honey as recited in claim 8, and further including a pump, said pump being operably coupled to said coil, said pump configured to provide recirculation of the heating fluid through said coil.

10. The honey processing apparatus that is operable to provide separation of wax and honey as recited in claim 9, and further including an emulsion introduction element, said emulsion introduction element being operably coupled to said second chamber, said emulsion introduction element having a first end and a second end being hollow therebetween, said emulsion introduction element configured to provide introduction of an emulsion into the interior volume of said second chamber.

11. The honey processing apparatus that is operable to provide separation of wax and honey as recited in claim 10, wherein the vessel is superposed a controllable heat source, said controllable heat source operable to provide an increase in temperature of the heating fluid disposed within the interior volume of the first chamber.

12. The honey processing apparatus that is operable to provide separation of wax and honey as recited in claim 11, and further including a first drain assembly, said first drain assembly including a drain tube and valve, said first drain assembly operably coupled to said interior volume of said first chamber.

13. The honey processing apparatus that is operable to provide separation of wax and honey as recited in claim 12, and further including an emulsion introduction element, said emulsion introduction element being operably coupled to said second chamber, said emulsion introduction element being hollow and having a first end and a second end, said second end being proximate the interior volume of said second chamber, said emulsion introduction element operable to facilitate introduction of a wax/honey emulsion during use of the honey processing apparatus.

14. The honey processing apparatus that is operable to provide separation of wax and honey as recited in claim 13, wherein the controllable heating source is configured to increase a temperature of the heating fluid to approximately sixty-three degrees centigrade.

15. The honey processing apparatus that is operable to provide separation of wax and honey as recited in claim 14, and further including a second drain assembly, said second drain assembly including a drain tube and valve, said second drain assembly operably coupled to said interior volume of said second chamber.

16. The honey processing apparatus that is operable to provide separation of wax and honey as recited in claim 15, wherein the vessel includes a lid, said lid operable to cover the opening of said first chamber and/or said second chamber.

17. The honey processing apparatus that is operable to provide separation of wax and honey as recited in claim 16, wherein said second drain assembly is proximate the upper end of said second chamber.
